(19) United States
(12) Patent Application Publication
(10) Pub. No.: US 2009/0260013 A1
(43) Pub. Date: Oct. 15, 2009

(54) Computer Processors With Plural, Pipelined Hardware Threads Of Execution

(75) Inventors: Timothy H. Heil, Rochester, MN (US); Brian L. Koehler, Rochester, MN (US); Robert A. Shearer, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/102,033

(22) Filed: Apr. 14, 2008

(51) Int. Cl. G06F 9/46

(52) U.S. Cl. 718/103

(57) ABSTRACT

Computer processors and methods of operation of computer processors that include a plurality of pipelined hardware threads of execution, each thread including a plurality of computer program instructions; an instruction decoder that determines dependencies and latencies among instructions of a thread; and an instruction dispatcher that arbitrates, in the presence of resource contention and in accordance with the dependencies and latencies, priorities for dispatch of instructions from the plurality of threads of execution.

### BACKGROUND OF THE INVENTION

1. Field of the Invention

The field of the invention is computer science, or, more specifically computer processors and methods of computer processor operation.

2. Description of Related Art

Many modern processor cores are optimized for use in fine-grain, multi-threading with multiple threads of execution implemented in hardware, with each such thread having its own dedicated set of architectural registers in the processor core. At least some such processor cores are capable of dispatching instructions from multiple hardware threads onto multiple execution engines simultaneously in multiple execution pipelines. In the presence of resource contention, when there are more instructions of a kind ready for dispatch than there are execution units of the same kind, such complex dispatching is a challenge.

There are two widely used paradigms of data processing in which such fine-grained multi-threading is useful: multiple instructions, multiple data (‘MIMD’) and single instruction, multiple data (‘SIMD’). In MIMD processing, a computer program is typically characterized as one or more threads of execution operating more or less independently, each requiring fast random access to large quantities of shared memory. MIMD is a data processing paradigm optimized for the particular classes of programs that fit it, including, for example, word processors, spreadsheets, database managers, many forms of telecommunications such as browsers, for example, and so on.

SIMD is characterized by a single program running simultaneously in parallel on many processors, each instance of the program operating in the same way but on separate items of data. SIMD is a data processing paradigm that is optimized for the particular classes of applications that fit it, including, for example, many forms of digital signal processing, vector processing, and so on.

There is another class of applications, however, including many real-world simulation programs, for example, for which neither pure SIMD nor pure MIMD data processing is optimized. That class of applications includes applications that benefit from parallel processing and also require fast random access to shared memory. For that class of programs, a pure MIMD system will not provide a high degree of parallelism and a pure SIMD system will not provide fast random access to main memory stores.

### SUMMARY OF THE INVENTION

Computer processors and methods of operation of computer processors that include a plurality of pipelined hardware threads of execution, each thread including a plurality of computer program instructions; an instruction decoder that determines dependencies and latencies among instructions of a thread; and an instruction dispatcher that arbitrates, in the presence of resource contention and in accordance with the dependencies and latencies, priorities for dispatch of instructions from the plurality of threads of execution.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful with computer processors and computer processor operations according to embodiments of the present invention.

FIG. 2 sets forth a functional block diagram of an example NOC with computer processors and computer processor operations according to embodiments of the present invention.

FIG. 3 sets forth a functional block diagram of a further example NOC with computer processors and computer processor operations according to embodiments of the present invention.

FIG. 4 sets forth an exemplary timing diagram that illustrates pipelined compute processor operations according to embodiments of the present invention.

FIG. 5 sets forth a functional block diagram of an exemplary computer processor according to embodiments of the present invention.

FIG. 6 sets forth a flow chart illustrating an exemplary method of operation of a NOC that implements in its IP blocks computer processors according to embodiments of the present invention.

FIG. 7 sets forth a flow chart illustrating an exemplary method of operation of a computer processor according to embodiments of the present invention.

### DETAILED DESCRIPTION OF EXEMPLARY EMBODIMENTS

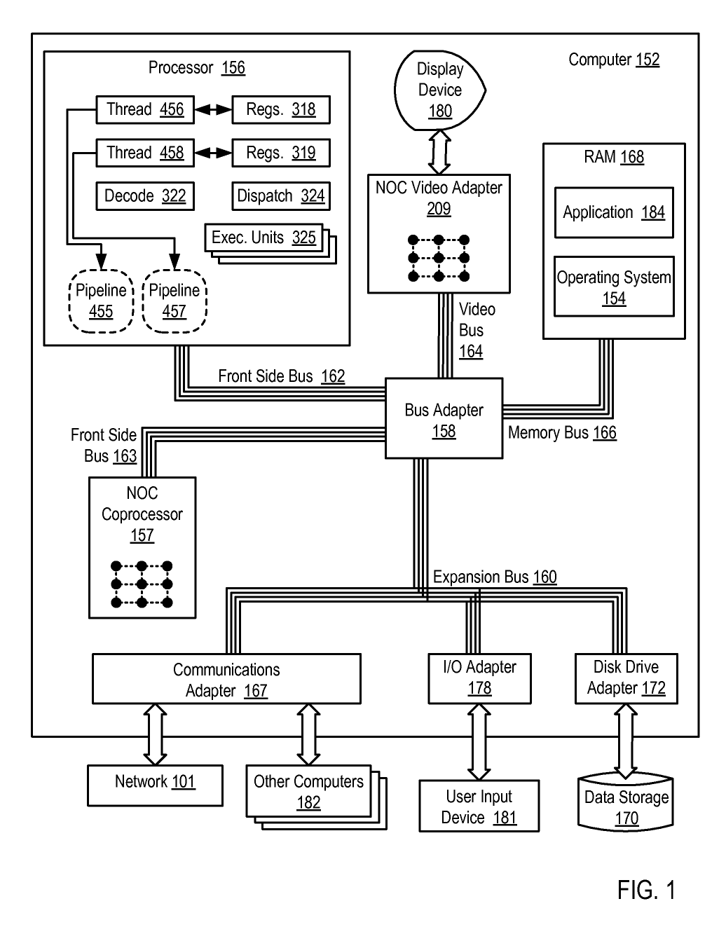

Exemplary apparatus and methods for computer processors and computer processor operations in accordance with the present invention are described with reference to the accompanying drawings, beginning with FIG. 1. FIG. 1 sets forth a block diagram of automated computing machinery comprising an exemplary computer (152) useful with computer processors and computer processor operations according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

The computer processor (156) in the example of FIG. 1 includes a plurality of pipelined hardware threads (446, 458) of execution. The threads are ‘pipelined’ (455, 457) in that the processor is configured with execution units (325) so that the processor can have under execution within the processor more than one instruction at the same time. The threads are hardware threads in that the support for the threads is built into the processor itself in the form of a separate architectural register set (318, 319) for each thread (456, 458), so that each thread can execute simultaneously with no need for context switches among the threads. Each such hardware thread can run multiple software threads of execution implemented with the software threads assigned to portions of processor time called ‘quanta’ or ‘time slots’ and context switches that save the contents of a set of architectural registers for a software thread during periods when that software thread loses possession of its assigned hardware thread.

Each thread (456, 458) in the example of FIG. 1 includes a plurality of computer program instructions. Each such computer program instruction is composed of an operation code or ‘opcode’ and one or more instruction parameters that advise the processor how to execute the opcode, where to obtain the input data for execution of an opcode, where to place the results of execution of an opcode, and so on. Depending on the context, the terms “computer program instruction,” “program instruction,” and “instruction” are used generally throughout this specification as synonyms. The terms “thread of execution” and “thread” are similarly used as synonyms in this specification. Moreover, unless the context specifically says otherwise, the terms “thread of execution” and “thread” in this specification always refer to pipelined hardware threads.

The computer processor (156) in the example of FIG. 1 also includes an instruction decoder (322) that determines dependencies and latencies among instructions of a thread. The instruction decoder (322) is a network of static and dynamic logic within the processor (156) that retrieves, for purposes of pipelining program instructions internally within the processor, instructions from registers in the register sets (318, 319) and decodes the instructions into microinstructions for execution on execution units (325) within the processor. Execution units (325) in the execution engine (340) execute microinstructions. Examples of execution units include LOAD execution units, STORE execution units, floating point execution units, execution units for integer arithmetic and logical operations, and so on.

A dependency exists when one instruction in a thread requires for its execution one or more of the results of execution of another instruction in the same thread, such as, for example, a BRANCH instruction that will execute only if the result of a previously-executed ADD instruction is zero. Determining dependencies among instructions is carried out by determining, for each thread, whether each instruction in the thread requires for its execution the results of execution of an earlier instruction in the thread. If it does, then a dependency is identified between that instruction and the previous instruction whose results are required.

Latency is a measure of the length of time required to make available to a subsequent instruction the results of execution of a previous instruction upon which the subsequent instruction is dependent. Latencies are associated in degree with dependencies. Latency for a zero result flag, in a status register, for example, may be effectively zero, available as soon as an ADD instruction that sets the flag is executed. Latency for return of a memory value for a LOAD instruction may represent many machine cycles before the LOAD results are available for use by a subsequent dependent instruction in the same thread of execution. Latency is determined therefore according to the dependency or type of dependency with which the latency is associated.

The computer processor (156) in the example of FIG. 1 also includes an instruction dispatcher (324) that arbitrates, in the presence of resource contention and in accordance with the dependencies and latencies, priorities for dispatch of instructions from the plurality of threads of execution (456, 458). The instruction dispatcher (324) is a network of static and dynamic logic within the processor (156) that dispatches, for purposes of pipelining program instructions internally within the processor, microinstructions to execution units (325) in the processor (156). The instruction dispatcher (324) can optionally be configured to arbitrate, in the presence of resource contention and in accordance with the dependencies and latencies, priorities for dispatch of instructions from the plurality of threads of execution by arbitrating priorities only on the basis of the existence of a dependency regardless of dependency type or latency, only according to dependency type, only according to latency, or only according to latency when the latency is larger than a predetermined threshold latency.

The term ‘resource contention’ is used here to refer to a condition in which there are more instructions ready for execution at the same time that there are hardware execution units available to execute those instruction. Resource contention exists, for example, when there are two floating point math instructions ready for execution at the same time but only one floating point execution unit in the processor. These two example instructions may be in the same thread of execution or in separate threads of execution. If one of these floating point instructions is dependent upon an immediately previous LOAD instruction and the second floating point instruction has no dependencies, then the dispatcher (324) arbitrates the priority for dispatch of these two instructions by dispatching the instruction having no dependencies before the instruction that will wait on the results of the LOAD. In this way, the floating point instruction without a dependency executes without delay. By the time the floating point instruction without dependency finishes executing, the LOAD results may be available, and the floating point instruction dependent on the LOAD may execute without delay. If the instruction with a dependency on a previous LOAD instruction is dispatched first, then both floating point instructions stall until the LOAD results become available.

TABLE 1
Microinstruction Queue

| Thread | Instr. | | | | |
|---|---|---|---|---|---|
| ID | ID | Opcode | Parms | Dependency | Latency |
| 00 | 000 | 000010001 | 010010001 | 000011111 | 010011110 |
| 00 | 001 | 000011001 | 010010001 | 000000000 | 000000000 |
| 00 | 010 | 001100001 | 001010000 | 000000000 | 000000000 |
| 00 | 011 | 000001110 | 100110001 | 110110111 | 111010011 |
| 00 | 100 | 111000100 | 010010000 | 000000000 | 000000000 |
| 01 | 000 | 000111001 | 001011001 | 101101101 | 101110101 |
| 01 | 001 | 011100000 | 010010100 | 000000000 | 000000000 |
| 01 | 010 | 000001001 | 001010010 | 111011010 | 111011100 |
| 01 | 011 | 000100001 | 001010001 | 000000000 | 000000000 |
| 01 | 100 | 001000000 | 001010000 | 000000000 | 000000000 |

For further explanation, Table 1 sets forth an example of two pipelined hardware threads of execution according to embodiments of the present invention. Each record in Table 1 represents a computer program instruction, or more particularly, a microinstruction in a microinstruction queue that has been decoded by an instruction decoder (322 on FIG. 1) and is ready to be dispatched by an instruction dispatcher (324) for execution on an execution unit (325) of the processor (156). Each microinstruction is stored in registers or high speed local memory within the processor. Each microinstruction includes a thread identifier (‘Thread ID’) represented by two binary bits of the microinstruction, capable of identifying microinstructions as belonging to one of four threads. Table 1 represents instructions commingled in the same memory space and identified as belonging to a particular hardware thread by use of a thread identifier. Readers will appreciate that, because each hardware thread is assigned to its own set of architectural registers, alternative architectures would assign each thread to its own separate memory or non-architectural register set within the processor, eliminating the need for a thread identifier as a component of a microinstruction.

In addition to a thread identifier, each microinstruction in the example of Table 1 also includes a microinstruction identifier (‘Instr. ID’), an operation code (‘Opcode’), instruction parameters (‘Parms’), a dependency identifier (‘Dependency’), and a latency identifier (‘Latency’). In addition to encoding a particular dependency, the dependency identifier can also encode the microinstruction identifier of a microinstruction from which another instruction depends, as well as dependency type. The latency identifier typically encodes the prospective number of processor clock cycles or the amount of time that an instruction will typically wait on a dependency if the dependent instruction is dispatched without arbitration of priorities. Dependency and latency values of 00000000 identify instructions having no dependency and no latency.

Stored in RAM (168) is an application program (184), a module of user-level computer program instructions for carrying out particular data processing tasks such as, for example, word processing, spreadsheets, database operations, video gaming, stock market simulations, atomic quantum process simulations, or other user-level applications. Also stored in RAM (168) is an operating system (154). Operating systems useful with computer processors and computer processor operations according to embodiments of the present invention include UNIX™, Linux™, Microsoft XP™, AIX™, IBM's i5/OS™, and others as will occur to those of skill in the art. The operating system (154) and the application (184) in the example of FIG. 1 are shown in RAM (168), but many components of such software typically are stored in non-volatile memory also, such as, for example, on a disk drive (170). The example computer (152) includes two example NOCs with computer processors and computer processor operations according to embodiments of the present invention: a video adapter (209) and a coprocessor (157). The video adapter (209) is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus. The example NOC coprocessor (157) is connected to processor (156) through bus adapter (158), and front side buses (162 and 163), which is also a high speed bus. The NOC coprocessor of FIG. 1 is optimized to accelerate particular data processing tasks at the behest of the main processor (156).

The example NOC video adapter (209) and NOC coprocessor (157) of FIG. 1 each include a NOC with computer processors and computer processor operations according to embodiments of the present invention, including integrated processor (‘IP’) blocks, routers, memory communications controllers, and network interface controllers, each IP block adapted to a router through a memory communications controller and a network interface controller, each memory communications controller controlling communication between an IP block and memory, and each network interface controller controlling inter-IP block communications through routers. Each IP block in such NOC devices (209, 157) can include one or more computer processors according to embodiments of the present invention. More details of NOC structure and operation are discussed below.

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers with computer processors and computer processor operations according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful with computer processors and computer processor operations according to embodiments of the present invention include modems for wired dial-up communications, Ethernet (IEEE 802.3) adapters for wired data communications network communications, and 802.11 adapters for wireless data communications network communications.

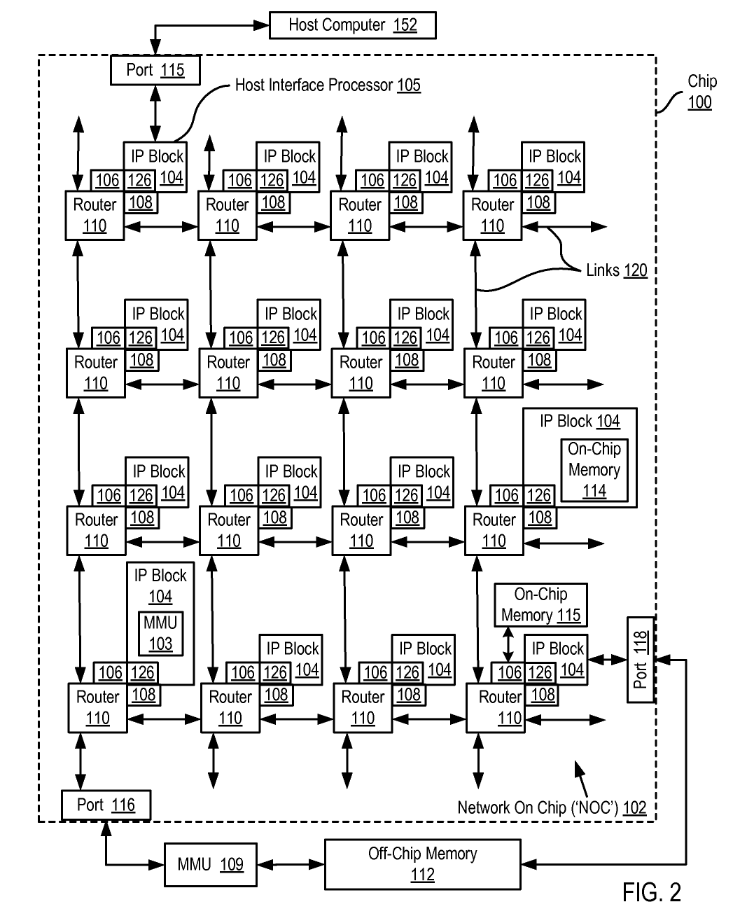

FIG. 2

For further explanation, FIG. 2 sets forth a functional block diagram of an example NOC (102) with computer processors and computer processor operations according to embodiments of the present invention. The NOC in the example of FIG. 2 is implemented on a ‘chip’ (100), that is, on an integrated circuit. The NOC (102) of FIG. 2 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110).

In the NOC (102) of FIG. 2, each IP block represents a reusable unit of synchronous or asynchronous logic design used as a building block for data processing within the NOC. The term ‘IP block’ is sometimes expanded as ‘intellectual property block,’ effectively designating an IP block as a design that is owned by a party, that is the intellectual property of a party, to be licensed to other users or designers of semiconductor circuits. In the scope of the present invention, however, there is no requirement that IP blocks be subject to any particular ownership, so the term is always expanded in this specification as ‘integrated processor block.’ IP blocks, as specified here, are reusable units of logic, cell, or chip layout design that may or may not be the subject of intellectual property. IP blocks are logic cores that can be formed as ASIC chip designs or FPGA logic designs, for example.

One way to describe IP blocks by analogy is that IP blocks are for NOC design what a library is for computer programming or a discrete integrated circuit component is for printed circuit board design. In NOCs that are useful with processors and methods of processor operation according to embodiments of the present invention, IP blocks may be implemented as generic gate netlists, as complete special purpose or general purpose microprocessors, or in other ways as may occur to those of skill in the art. A netlist is a Boolean-algebra representation (gates, standard cells) of an IP block's logical-function, analogous to an assembly-code listing for a high-level program application. NOCs also may be implemented, for example, in synthesizable form, described in a hardware description language such as Verilog or VHDL. In addition to netlist and synthesizable implementation, NOCs also may be delivered in lower-level, physical descriptions. Analog IP block elements such as SERDES, PLL, DAC, ADC, and so on, may be distributed in a transistor-layout format such as GDSII. Digital elements of IP blocks are sometimes offered in layout format as well. In the example of FIG. 2, each IP block (104) implements a general purpose microprocessor (126) that operates multiple pipelined hardware threads of execution according to embodiments of the present invention. Each such microprocessor (126) in this example includes an instruction decoder that determines dependencies and latencies among instructions of a thread and an instruction dispatcher that arbitrates, in the presence of resource contention and in accordance with the dependencies and latencies, priorities for dispatch of instructions from the plurality of threads of execution.

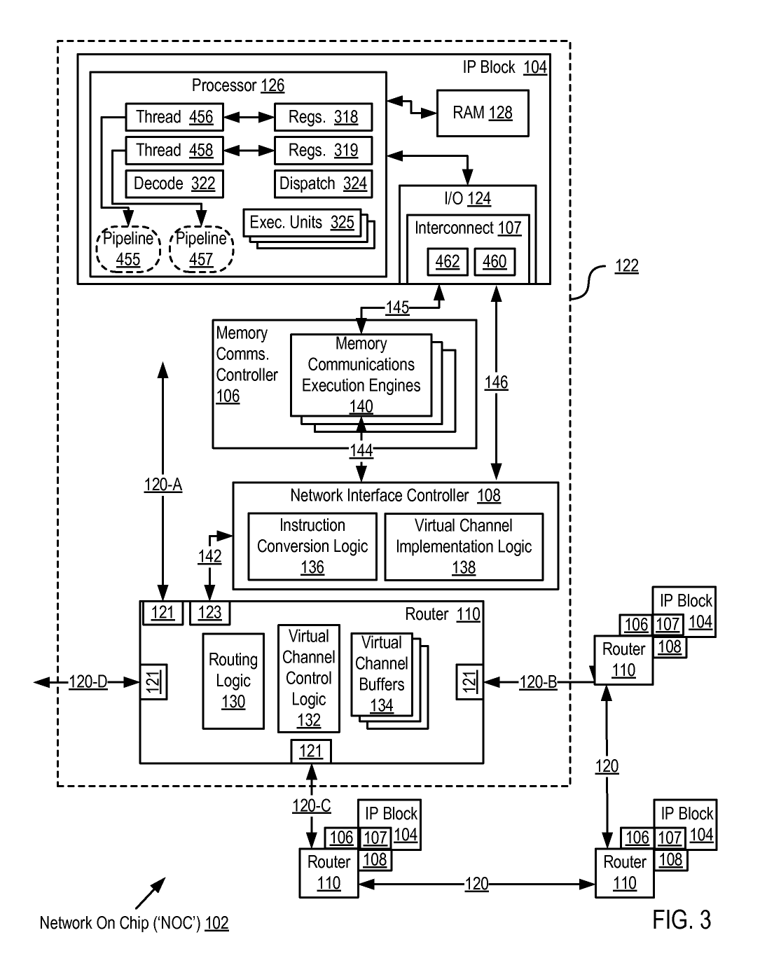

Each IP block (104) in the example of FIG. 2 is adapted to a router (110) through a memory communications controller (106). Each memory communication controller is an aggregation of synchronous and asynchronous logic circuitry adapted to provide data communications between an IP block and memory. Examples of such communications between IP blocks and memory include memory load instructions and memory store instructions. The memory communications controllers (106) are described in more detail below with reference to FIG. 3.

Each IP block (104) in the example of FIG. 2 is also adapted to a router (110) through a network interface controller (108). Each network interface controller (108) controls communications through routers (110) between IP blocks (104). Examples of communications between IP blocks include messages carrying data and instructions for processing the data among IP blocks in parallel applications and in pipelined applications. The network interface controllers (108) are described in more detail below with reference to FIG. 3.

Each IP block (104) in the example of FIG. 2 is adapted to a router (110). The routers (110) and links (120) among the routers implement the network operations of the NOC. The links (120) are packet structures implemented on physical, parallel wire buses connecting all the routers. That is, each link is implemented on a wire bus wide enough to accommodate simultaneously an entire data switching packet, including all header information and payload data. If a packet structure includes 64 bytes, for example, including an eight byte header and 56 bytes of payload data, then the wire bus subtending each link is 64 bytes wise, 512 wires. In addition, each link is bidirectional, so that if the link packet structure includes 64 bytes, the wire bus actually contains 1024 wires between each router and each of its neighbors in the network. A message can includes more than one packet, but each packet fits precisely onto the width of the wire bus. If the connection between the router and each section of wire bus is referred to as a port, then each router includes five ports, one for each of four directions of data transmission on the network and a fifth port for adapting the router to a particular IP block through a memory communications controller and a network interface controller.

Each memory communications controller (106) in the example of FIG. 2 controls communications between an IP block and memory. Memory can include off-chip main RAM (112), memory (115) connected directly to an IP block through a memory communications controller (106), on-chip memory enabled as an IP block (114), and on-chip caches. In the NOC of FIG. 2, either of the on-chip memories (114, 115), for example, may be implemented as on-chip cache memory. All these forms of memory can be disposed in the same address space, physical addresses or virtual addresses, true even for the memory attached directly to an IP block. Memory-addressed messages therefore can be entirely bidirectional with respect to IP blocks, because such memory can be addressed directly from any IP block anywhere on the network. Memory (114) on an IP block can be addressed from that IP block or from any other IP block in the NOC. Memory (115) attached directly to a memory communication controller can be addressed by the IP block that is adapted to the network by that memory communication controller—and can also be addressed from any other IP block anywhere in the NOC.

The example NOC includes two memory management units (‘MMUs’) (103, 109), illustrating two alternative memory architectures for NOCs with computer processors and computer processor operations according to embodiments of the present invention. MMU (103) is implemented with an IP block, allowing a processor within the IP block to operate in virtual memory while allowing the entire remaining architecture of the NOC to operate in a physical memory address space. The MMU (109) is implemented off-chip, connected to the NOC through a data communications port (116). The port (116) includes the pins and other interconnections required to conduct signals between the NOC and the MMU, as well as sufficient intelligence to convert message packets from the NOC packet format to the bus format required by the external MMU (109). The external location of the MMU means that all processors in all IP blocks of the NOC can operate in virtual memory address space, with all conversions to physical addresses of the off-chip memory handled by the off-chip MMU (109).

In addition to the two memory architectures illustrated by use of the MMUs (103, 109), data communications port (118) illustrates a third memory architecture useful in NOCs with computer processors and computer processor operations according to embodiments of the present invention. Port (118) provides a direct connection between an IP block (104) of the NOC (102) and off-chip memory (112). With no MMU in the processing path, this architecture provides utilization of a physical address space by all the IP blocks of the NOC. In sharing the address space bi-directionally, all the IP blocks of the NOC can access memory in the address space by memory-addressed messages, including loads and stores, directed through the IP block connected directly to the port (118). The port (118) includes the pins and other interconnections required to conduct signals between the NOC and the off-chip memory (112), as well as sufficient intelligence to convert message packets from the NOC packet format to the bus format required by the off-chip memory (112).

In the example of FIG. 2, one of the IP blocks is designated a host interface processor (105). A host interface processor (105) provides an interface between the NOC and a host computer (152) in which the NOC may be installed and also provides data processing services to the other IP blocks on the NOC, including, for example, receiving and dispatching among the IP blocks of the NOC data processing requests from the host computer. A NOC may, for example, implement a video graphics adapter (209) or a coprocessor (157) on a larger computer (152) as described above with reference to FIG. 1. In the example of FIG. 2, the host interface processor (105) is connected to the larger host computer through a data communications port (115). The port (115) includes the pins and other interconnections required to conduct signals between the NOC and the host computer, as well as sufficient intelligence to convert message packets from the NOC to the bus format required by the host computer (152). In the example of the NOC coprocessor in the computer of FIG. 1, such a port would provide data communications format translation between the link structure of the NOC coprocessor (157) and the protocol required for the front side bus (163) between the NOC coprocessor (157) and the bus adapter (158).

For further explanation, FIG. 3 sets forth a functional block diagram of a further example NOC with computer processors and computer processor operations according to embodiments of the present invention. The example NOC of FIG. 3 is similar to the example NOC of FIG. 2 in that the example NOC of FIG. 3 is implemented on a chip (100 on FIG. 2), and the NOC (102) of FIG. 3 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110). In the example of FIG. 3, one set (122) of an IP block (104) adapted to a router (110) through a memory communications controller (106) and network interface controller (108) is expanded to aid a more detailed explanation of their structure and operations. All the IP blocks, memory communications controllers, network interface controllers, and routers in the example of FIG. 3 are configured in the same manner as the expanded set (122).

In the example of FIG. 3, each IP block (104) includes a computer processor (126) and I/O functionality (124). In this example, computer memory is represented by a segment of random access memory (‘RAM’) (128) in each IP block (104). The memory, as described above with reference to the example of FIG. 2, can occupy segments of a physical address space whose contents on each IP block are addressable and accessible from any IP block in the NOC. The processors (126), I/O capabilities (124), and memory (128) on each IP block effectively implement the IP blocks as generally programmable microcomputers. In the example of FIG. 3, each IP block includes a low latency, high bandwidth application messaging interconnect (107) that adapts the IP block to the network for purposes of data communications among IP blocks. Each such messaging interconnect includes an inbox (460) and an outbox (462).

Each IP block also includes a computer processor (126) according to embodiments of the present invention, a computer processor that includes a plurality of pipelined (455, 457) hardware threads of execution (456, 458), each thread comprising a plurality of computer program instructions; an instruction decoder (322) that determines dependencies and latencies among instructions of a thread; and an instruction dispatcher (324) that arbitrates, in the presence of resource contention and in accordance with the dependencies and latencies, priorities for dispatch of instructions from the plurality of threads of execution. The threads (456, 458) are ‘pipelined’ (455, 457) in that the processor is configured with execution units (325) so that the processor can have under execution within the processor more than one instruction at the same time. The threads are hardware threads in that the support for the threads is built into the processor itself in the form of a separate architectural register set (318, 319) for each thread (456, 458), so that each thread can execute simultaneously with no need for context switches among the threads. Each such hardware thread (456, 458) can run multiple software threads of execution implemented with the software threads assigned to portions of processor time called ‘quanta’ or ‘time slots’ and context switches that save the contents of a set of architectural registers for a software thread during periods when that software thread loses possession of its assigned hardware thread.

The instruction decoder (322) is a network of static and dynamic logic within the processor (156) that retrieves, for purposes of pipelining program instructions internally within the processor, instructions from registers in the register sets (318, 319) and decodes the instructions into microinstructions for execution on execution units (325) within the processor. The instruction dispatcher (324) is a network of static and dynamic logic within the processor (156) that dispatches, for purposes of pipelining program instructions internally within the processor, microinstructions to execution units (325) in the processor (156). The instruction dispatcher (324) can optionally be configured to arbitrate, in the presence of resource contention and in accordance with the dependencies and latencies, priorities for dispatch of instructions from the plurality of threads of execution by arbitrating priorities only on the basis of the existence of a dependency regardless of dependency type or latency, only according to dependency type, only according to latency, or only according to latency when the latency is larger than a predetermined threshold latency.

In the NOC (102) of FIG. 3, each memory communications controller (106) includes a plurality of memory communications execution engines (140). Each memory communications execution engine (140) is enabled to execute memory communications instructions from an IP block (104), including bidirectional memory communications instruction flow (142, 144, 145) between the network and the IP block (104). The memory communications instructions executed by the memory communications controller may originate, not only from the IP block adapted to a router through a particular memory communications controller, but also from any IP block (104) anywhere in the NOC (102). That is, any IP block in the NOC can generate a memory communications instruction and transmit that memory communications instruction through the routers of the NOC to another memory communications controller associated with another IP block for execution of that memory communications instruction. Such memory communications instructions can include, for example, translation lookaside buffer control instructions, cache control instructions, barrier instructions, and memory load and store instructions. Each memory communications execution engine (140) is enabled to execute a complete memory communications instruction separately and in parallel with other memory communications execution engines. The memory communications execution engines implement a scalable memory transaction processor optimized for concurrent throughput of memory communications instructions. The memory communications controller (106) supports multiple memory communications execution engines (140) all of which run concurrently for simultaneous execution of multiple memory communications instructions. A new memory communications instruction is allocated by the memory communications controller (106) to a memory communications engine (140) and the memory communications execution engines (140) can accept multiple response events simultaneously. In this example, all of the memory communications execution engines (140) are identical. Scaling the number of memory communications instructions that can be handled simultaneously by a memory communications controller (106), therefore, is implemented by scaling the number of memory communications execution engines (140).

In the NOC (102) of FIG. 3, each network interface controller (108) is enabled to convert communications instructions from command format to network packet format for transmission among the IP blocks (104) through routers (110). The communications instructions are formulated in command format by the IP block (104) or by the memory communications controller (106) and provided to the network interface controller (108) in command format. The command format is a native format that conforms to architectural register files of the IP block (104) and the memory communications controller (106). The network packet format is the format required for transmission through routers (110) of the network. Each such message is composed of one or more network packets. Examples of such communications instructions that are converted from command format to packet format in the network interface controller include memory load instructions and memory store instructions between IP blocks and memory. Such communications instructions may also include communications instructions that send messages among IP blocks carrying data and instructions for processing the data among IP blocks in parallel applications and in pipelined applications.

In the NOC (102) of FIG. 3, each IP block is enabled to send memory-address-based communications to and from memory through the IP block's memory communications controller and then also through its network interface controller to the network. A memory-address-based communications is a memory access instruction, such as a load instruction or a store instruction, that is executed by a memory communication execution engine of a memory communications controller of an IP block. Such memory-address-based communications typically originate in an IP block, formulated in command format, and handed off to a memory communications controller for execution.

Many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. All memory-address-based communication that are executed with message traffic are passed from the memory communications controller to an associated network interface controller for conversion (136) from command format to packet format and transmission through the network in a message. In converting to packet format, the network interface controller also identifies a network address for the packet in dependence upon the memory address or addresses to be accessed by a memory-address-based communication. Memory address based messages are addressed with memory addresses. Each memory address is mapped by the network interface controllers to a network address, typically the network location of a memory communications controller responsible for some range of physical memory addresses. The network location of a memory communication controller (106) is naturally also the network location of that memory communication controller's associated router (110), network interface controller (108), and IP block (104). The instruction conversion logic (136) within each network interface controller is capable of converting memory addresses to network addresses for purposes of transmitting memory-address-based communications through routers of a NOC.

Upon receiving message traffic from routers (110) of the network, each network interface controller (108) inspects each packet for memory instructions. Each packet containing a memory instruction is handed to the memory communications controller (106) associated with the receiving network interface controller, which executes the memory instruction before sending the remaining payload of the packet to the IP block for further processing. In this way, memory contents are always prepared to support data processing by an IP block before the IP block begins execution of instructions from a message that depend upon particular memory content.

In the NOC (102) of FIG. 3, each IP block (104) is enabled to bypass its memory communications controller (106) and send inter-IP block, network-addressed communications (146) directly to the network through the IP block's network interface controller (108). Network-addressed communications are messages directed by a network address to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through it I/O functions (124) directly to the IP block's network interface controller in command format, then converted to packet format by the network interface controller and transmitted through routers of the NOC to another IP block. Such network-addressed communications (146) are bi-directional, potentially proceeding to and from each IP block of the NOC, depending on their use in any particular application. Each network interface controller, however, is enabled to both send and receive (142) such communications to and from an associated router, and each network interface controller is enabled to both send and receive (146) such communications directly to and from an associated IP block, bypassing an associated memory communications controller (106).

Each network interface controller (108) in the example of FIG. 3 is also enabled to implement virtual channels on the network, characterizing network packets by type. Each network interface controller (108) includes virtual channel implementation logic (138) that classifies each communication instruction by type and records the type of instruction in a field of the network packet format before handing off the instruction in packet form to a router (110) for transmission on the NOC. Examples of communication instruction types include inter-IP block network-address-based messages, request messages, responses to request messages, invalidate messages directed to caches; memory load and store messages; and responses to memory load messages, and so on.

Each router (110) in the example of FIG. 3 includes routing logic (130), virtual channel control logic (132), and virtual channel buffers (134). The routing logic typically is implemented as a network of synchronous and asynchronous logic that implements a data communications protocol stack for data communication in the network formed by the routers (110), links (120), and bus wires among the routers. The routing logic (130) includes the functionality that readers of skill in the art might associate in off-chip networks with routing tables, routing tables in at least some embodiments being considered too slow and cumbersome for use in a NOC. Routing logic implemented as a network of synchronous and asynchronous logic can be configured to make routing decisions as fast as a single clock cycle. The routing logic in this example routes packets by selecting a port for forwarding each packet received in a router. Each packet contains a network address to which the packet is to be routed. Each router in this example includes five ports, four ports (121) connected through bus wires (120-A, 120-B, 120-C, 120-D) to other routers and a fifth port (123) connecting each router to its associated IP block (104) through a network interface controller (108) and a memory communications controller (106).

In describing memory-address-based communications above, each memory address was described as mapped by network interface controllers to a network address, a network location of a memory communications controller. The network location of a memory communication controller (106) is naturally also the network location of that memory communication controller's associated router (110), network interface controller (108), and IP block (104). In inter-IP block, or network-address-based communications, therefore, it is also typical for application-level data processing to view network addresses as location of IP block within the network formed by the routers, links, and bus wires of the NOC. FIG. 2 illustrates that one organization of such a network is a mesh of rows and columns in which each network address can be implemented, for example, as either a unique identifier for each set of associated router, IP block, memory communications controller, and network interface controller of the mesh or x,y coordinates of each such set in the mesh.

In the NOC (102) of FIG. 3, each router (110) implements two or more virtual communications channels, where each virtual communications channel is characterized by a communication type. Communication instruction types, and therefore virtual channel types, include those mentioned above: inter-IP block network-address-based messages, request messages, responses to request messages, invalidate messages directed to caches; memory load and store messages; and responses to memory load messages, and so on. In support of virtual channels, each router (110) in the example of FIG. 3 also includes virtual channel control logic (132) and virtual channel buffers (134). The virtual channel control logic (132) examines each received packet for its assigned communications type and places each packet in an outgoing virtual channel buffer for that communications type for transmission through a port to a neighboring router on the NOC.

Each virtual channel buffer (134) has finite storage space. When many packets are received in a short period of time, a virtual channel buffer can fill up—so that no more packets can be put in the buffer. In other protocols, packets arriving on a virtual channel whose buffer is full would be dropped. Each virtual channel buffer (134) in this example, however, is enabled with control signals of the bus wires to advise surrounding routers through the virtual channel control logic to suspend transmission in a virtual channel, that is, suspend transmission of packets of a particular communications type. When one virtual channel is so suspended, all other virtual channels are unaffected—and can continue to operate at full capacity. The control signals are wired all the way back through each router to each router's associated network interface controller (108). Each network interface controller is configured to, upon receipt of such a signal, refuse to accept, from its associated memory communications controller (106) or from its associated IP block (104), communications instructions for the suspended virtual channel. In this way, suspension of a virtual channel affects all the hardware that implements the virtual channel, all the way back up to the originating IP blocks.

One effect of suspending packet transmissions in a virtual channel is that no packets are ever dropped in the architecture of FIG. 3. When a router encounters a situation in which a packet might be dropped in some unreliable protocol such as, for example, the Internet Protocol, the routers in the example of FIG. 3 suspend by their virtual channel buffers (134) and their virtual channel control logic (132) all transmissions of packets in a virtual channel until buffer space is again available, eliminating any need to drop packets. The NOC of FIG. 3, therefore, implements highly reliable network communications protocols with an extremely thin layer of hardware.

A computer processor according to embodiments of the present invention includes multiple execution units to support processing in multiple pipelines of more than one instruction at a time. A ‘pipeline,’ as the term is used here, is a hardware pipeline, a set of data processing elements connected in series within a processor, so that the output of one processing element is the input of the next one. Each element in such a series of elements is referred to as a ‘stage,’ so that pipelines are characterized by a particular number of stages, a three-stage pipeline, a four-stage pipeline, and so on. All pipelines have at least two stages, and some pipelines have more than a dozen stages. The processing elements that make up the stages of a pipeline are the logical circuits that implement the various stages of an instruction, such as, for example, instruction decoding, address decoding, instruction dispatching, arithmetic, logic operations, register fetching, cache lookup, writebacks of result values from non-architectural registers to architectural registers upon completion of an instruction, and so on. Implementation of a pipeline allows a processor to operate more efficiently because a computer program instruction can execute simultaneously with other computer program instructions, one instruction or microinstruction in each stage of the pipeline at the same time. Thus a five-stage pipeline can have five computer program instructions executing in the pipeline at the same time, one being fetched from a register, one being decoded, one in execution in an execution unit, one retrieving additional required data from memory, and one having its results written back to a register, all at the same time on the same clock cycle.

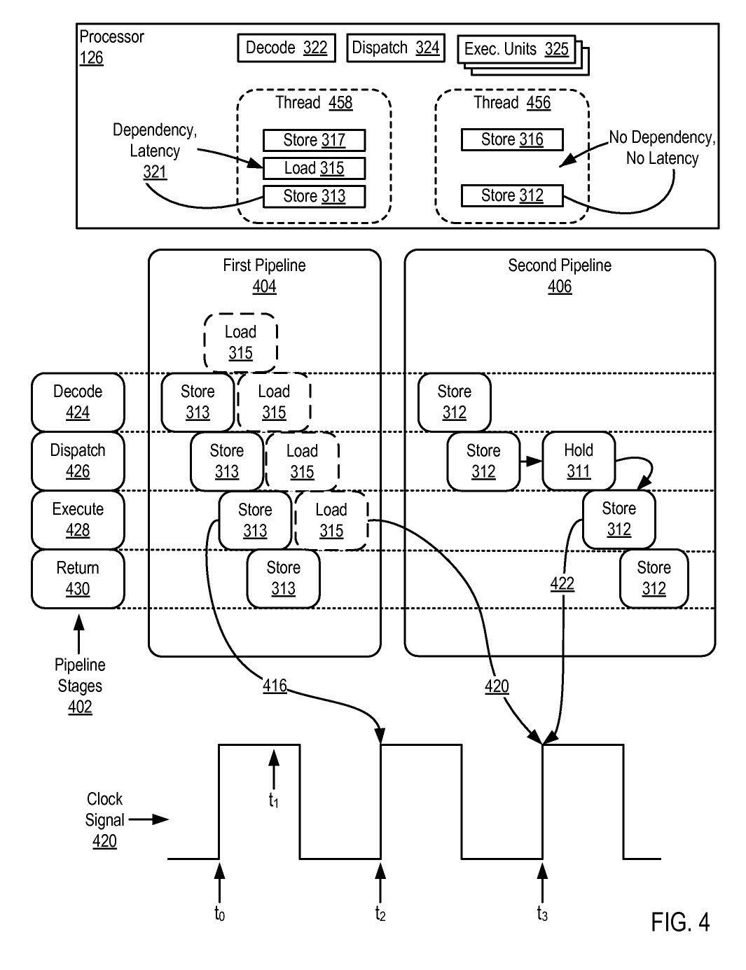

For further explanation, FIG. 4 sets forth an exemplary timing diagram that illustrates pipelined computer processor operation according to embodiments of the present invention. The timing diagram of FIG. 4 illustrates the operation of a computer processor that supports a plurality of pipelined hardware threads of execution (456, 458), each thread comprising a plurality of computer program instructions; an instruction decoder (322) that determines dependencies and latencies among instructions of a thread; and an instruction dispatcher (324) that arbitrates, in the presence of resource contention and in accordance with the dependencies and latencies, priorities for dispatch of instructions from the plurality of threads of execution. The processor in this example includes several execution units (325), including one or more LOAD execution units, but only one STORE execution unit. The timing diagram of FIG. 4 illustrates the progress through pipeline stages (402) of two pipelines (404, 406) for two STORE instructions (312, 313) and a LOAD instruction (315). The LOAD instruction (315) is dependent (321) upon STORE instruction (313). STORE instruction (312) has no dependent instructions. Although processor design does not necessarily require that each pipeline stage be executed in one processor clock cycle, it is assumed here for ease of explanation, that each of the pipeline stages in the example of FIG. 4 requires one clock cycle to complete the stage—provided, of course, that the instruction does not stall waiting upon a dependency. Clock signal (420) illustrates the timing of dispatch and execution in stages of the pipelines (404, 406). The two STORE instructions (312, 313) enter the pipelines simultaneously, on the same clock cycle, are decoded (424), and become ready for dispatch (426) also on the same clock cycle at time to. There is resource contention between the two STORE instructions because they are both ready for dispatch at the same time in a processor with only one STORE execution unit. In the presence of resource contention, one of instruction will have to wait for an execution unit, and the process of arbitrating priority is the process of determining which instruction will be the first to gain possession of a pertinent execution unit. In the example of FIG. 4, the instruction dispatcher (324) operates between times to and t₁ by examining dependencies and arbitrating priorities between the two STORE instructions. If the instruction dispatcher were to dispatch STORE instruction (312), which has no other instructions dependent upon it, at time t₂, for example, then the other STORE instruction (313) and its dependent LOAD instruction (315) could both be dispatched for execution simultaneously at time t₃. If STORE instruction (313) and its dependent LOAD instruction (315) were both dispatched for execution simultaneously, the LOAD execution engine to which the LOAD instruction is dispatched will stall for the duration of the latency for the STORE instruction—in this example only one clock cycle—in other embodiments possibly many clock cycles.

In the example of FIG. 4, therefore, the instruction dispatcher (324) arbitrates priority between the STORE instructions (312, 313) by holding (311) STORE instruction (312) ready for dispatch and dispatching the STORE instruction (313) having a dependent (321) LOAD instruction (315) for execution at time t₂. The instruction dispatcher then dispatches the dependent LOAD instruction (315) for execution one clock cycle later at time t₃. In this way, the STORE instruction (313) completes execution by time t₃, and the LOAD execution unit to which the dependent LOAD instruction (315) is dispatched will not stall to wait through the latency of execution for the STORE instruction (313) upon which it is dependent. The other STORE instruction (312) is also dispatched for execution at time t₃, after STORE instruction (313) has completed execution upon the one available STORE execution unit.

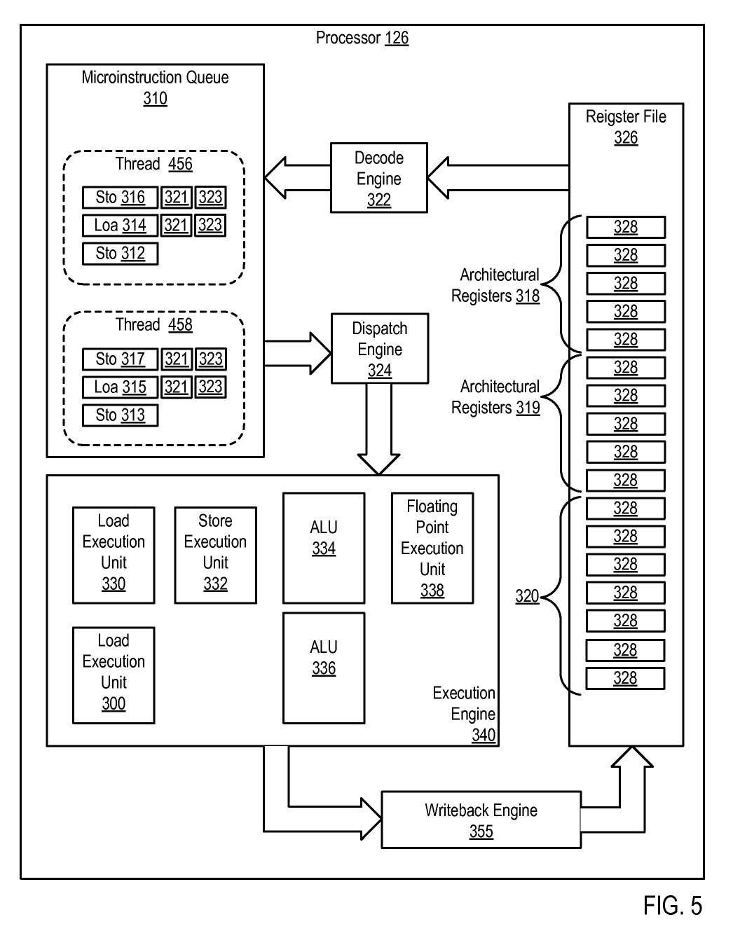

For further explanation, FIG. 5 sets forth a functional block diagram of an exemplary computer processor (126) according to embodiments of the present invention. Such a processor may be implemented as part of a generally programmable computer, an embedded system, as an IP block on a NOC, and in other ways that will occur to those of skill in the art. The processor (126) in this example includes a plurality of pipelined hardware threads of execution (456, 458), each thread comprising a plurality of computer program instructions (312, 314, 316, 313, 315, 317). The threads (456, 458) are ‘pipelined’ (455, 457) in that the processor is configured with execution units (300, 330, 332, 334, 336, 338) in an execution engine (340) so that the processor can have under execution within the processor more than one instruction at the same time. The threads are hardware threads in that the support for the threads is built into the processor itself in the form of a separate architectural register set (318, 319) for each thread (456, 458), so that each thread can execute simultaneously with no need for context switches among the threads. Each such hardware thread (456, 458) can run multiple software threads of execution implemented with the software threads assigned to portions of processor time called ‘quanta’ or ‘time slots’ and context switches that save the contents of a set of architectural registers for a software thread during periods when that software thread loses possession of its assigned hardware thread.

The processor (126) in this example includes a register file (326) made up of all the registers (328) of the processor. The register file (326) is an array of processor registers implemented, for example, with fast static memory devices. The registers include registers (320) that are accessible only by the execution units as well as two sets of ‘architectural registers’ (318, 319), one set for each hardware thread (456, 458). The instruction set architecture of processor (126) defines a set of registers, called ‘architectural registers,’ that are used to stage data between memory and the execution units in the processor. The architectural registers are the registers that are accessible directly by user-level computer program instructions.

The processor (126) includes a decode engine (322), a dispatch engine (324), an execution engine (340), and a writeback engine (355). The decode engine (322) is an example of an instruction decoder within the meaning of the present invention, and the dispatch engine is an example of an instruction dispatcher within the meaning of the present invention. Each of these engines is a network of static and dynamic logic within the processor (126) that carries out particular functions for pipelining program instructions internally within the processor.

The instruction decoder (322) is a network of static and dynamic logic within the processor (156) that retrieves, for purposes of pipelining program instructions internally within the processor, instructions from registers in the register sets (318, 319) and decodes the instructions into microinstructions for execution on execution units (325) within the processor. In addition, the decode engine (322) determines dependencies (321) and latencies (323) among instructions (312, 314, 316, 313, 315, 317) of the threads (456, 458), and makes the dependencies and latencies available to the dispatch engine (324) for use in arbitrating priorities in the presence of resource contention.

The processor's decode engine (322) that reads a user-level computer program instruction from an architectural register and decodes that instruction into one or more microinstructions for insertion into a microinstruction queue (310). Just as a single high level language instruction is compiled and assembled to a series of machine instructions (load, store, shift, etc), each machine instruction is in turn implemented by a series of microinstructions. Such a series of microinstructions is sometimes called a ‘microprogram’ or ‘microcode.’ The microinstructions are sometimes referred to as ‘micro-operations,’ ‘micro-ops,’ or ‘pops’—although in this specification, a microinstruction is generally referred to as a ‘microinstruction,’ a ‘computer instruction,’ or simply as an ‘instruction.’

Microprograms are carefully designed and optimized for the fastest possible execution, since a slow microprogram would yield a slow machine instruction which would in turn cause all programs using that instruction to be slow. Microinstructions, for example, may specify such fundamental operations as the following:
Connect Register 1 to the “A” side of the ALU
Connect Register 7 to the “B” side of the ALU
Set the ALU to perform two's-complement addition
Set the ALU's carry input to zero
Store the result value in Register 8
Update the “condition codes” with the ALU status flags (“Negative”, “Zero”, “Overflow”, and “Carry”)
Microjump to MicroPC nnn for the next microinstruction

For a further example: A typical assembly language instruction to add two numbers, such as, for example, ADD A, B, C, may add the values found in memory locations A and B and then put the result in memory location C. In processor (126), the decode engine (322) may break this user-level instruction into a series of microinstructions similar to:
LOAD A, Reg1
LOAD B, Reg2
ADD Reg1, Reg2, Reg3
STORE Reg3, C

It is these microinstructions that are then placed in the microinstruction queue (310) to be dispatched to execution units.

The processor (126) includes an execution engine (340) that in turn includes several execution units, two load memory instruction execution units (330, 300), a store memory instruction execution unit (332), two ALUs (334, 336), and a floating point execution unit (338). The microinstruction queue (310) in this example includes a first store microinstruction (312), a corresponding load microinstruction (314), and a second store microinstruction (316). The load instruction (314) is said to correspond to the first store instruction (312) because the dispatch engine (324) is able to dispatch both the first store instruction (312) and its corresponding load instruction (314) into the execution engine (340) at the same time, on the same clock cycle. The dispatch engine can do so because the execution engine supports two or more pipelines of execution, so that two or more microinstructions can move through the execution portion of the pipelines at exactly the same time.

Processor (126) also includes a dispatch engine (324) that carries out the work of dispatching individual microinstructions from the microinstruction queue to execution units. Execution units in the execution engine (340) execute the microinstructions, and the writeback engine (355) writes the results of execution back into the correct registers in the register file (326). The dispatch engine (324) is an example of an instruction dispatcher (324) that arbitrates, in the presence of resource contention and in accordance with the dependencies (321) and latencies (323), priorities for dispatch of instructions (312, 314, 316, 313, 315, 317) from the threads of execution (456, 458). The dispatch engine (324) is a network of static and dynamic logic within the processor (156) that dispatches, for purposes of pipelining program instructions internally within the processor, microinstructions to execution units (325) in the processor (156). The instruction dispatcher (324) can optionally be configured to arbitrate, in the presence of resource contention and in accordance with the dependencies and latencies, priorities for dispatch of instructions from the plurality of threads of execution by arbitrating priorities only on the basis of the existence of a dependency regardless of dependency type or latency, only according to dependency type, only according to latency, or only according to latency when the latency is larger than a predetermined threshold latency.

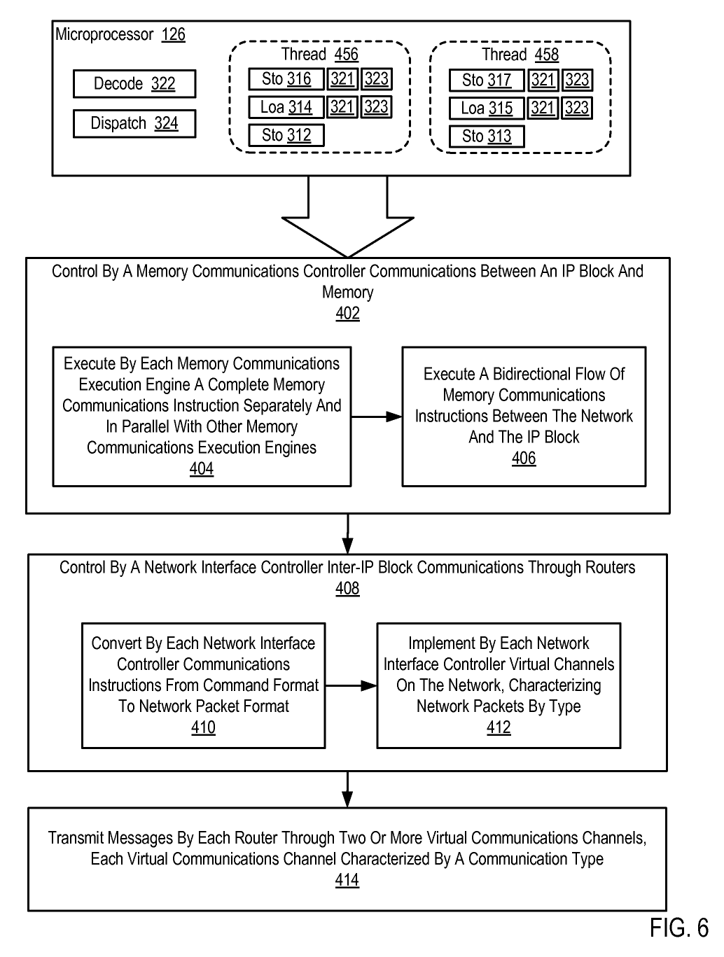

For further explanation, FIG. 6 sets forth a flow chart illustrating an exemplary method of operation of a NOC that implements in its IP blocks computer processors according to embodiments of the present invention. The method of FIG. 6 is implemented on a NOC similar to the ones described above in this specification, a NOC (102 on FIG. 3) that is implemented on a chip (100 on FIG. 3) with IP blocks (104 on FIG. 3), routers (110 on FIG. 3), memory communications controllers (106 on FIG. 3), and network interface controllers (108 on FIG. 3). Each IP block (104 on FIG. 3) is adapted to a router (110 on FIG. 3) through a memory communications controller (106 on FIG. 3) and a network interface controller (108 on FIG. 3). A NOC that operates according to the method of FIG. 6 implements in its IP blocks at least one microprocessor (126) that operates multiple pipelined hardware threads of execution (456, 458) according to embodiments of the present invention. Each such microprocessor includes an instruction decoder (322) that determines dependencies (321) and latencies (323) among instructions (300, 330, 332, 334, 336, 338) of a thread and an instruction dispatcher (324) that arbitrates, in the presence of resource contention and in accordance with the dependencies and latencies, priorities for dispatch of instructions from the threads of execution.

The method of FIG. 6 includes controlling (402) by a memory communications controller (106 on FIG. 3) communications between an IP block and memory. In the method of FIG. 6, the memory communications controller includes a plurality of memory communications execution engines (140 on FIG. 3). Also in the method of FIG. 6, controlling (402) communications between an IP block and memory is carried out by executing (404) by each memory communications execution engine a complete memory communications instruction separately and in parallel with other memory communications execution engines and executing (406) a bidirectional flow of memory communications instructions between the network and the IP block. In the method of FIG. 6, memory communications instructions may include translation lookaside buffer control instructions, cache control instructions, barrier instructions, memory load instructions, and memory store instructions. In the method of FIG. 6, memory may include off-chip main RAM, memory connected directly to an IP block through a memory communications controller, on-chip memory enabled as an IP block, and on-chip caches.

The method of FIG. 6 also includes controlling (408) by a network interface controller (108 on FIG. 3) inter-IP block communications through routers. In the method of FIG. 6, controlling (408) inter-IP block communications also includes converting (410) by each network interface controller communications instructions from command format to network packet format and implementing (412) by each network interface controller virtual channels on the network, including characterizing network packets by type.

The method of FIG. 6 also includes transmitting (414) messages by each router (110 on FIG. 3) through two or more virtual communications channels, where each virtual communications channel is characterized by a communication type. Communication instruction types, and therefore virtual channel types, include, for example: inter-IP block network-address-based messages, request messages, responses to request messages, invalidate messages directed to caches; memory load and store messages; and responses to memory load messages, and so on. In support of virtual channels, each router also includes virtual channel control logic (132 on FIG. 3) and virtual channel buffers (134 on FIG. 3). The virtual channel control logic examines each received packet for its assigned communications type and places each packet in an outgoing virtual channel buffer for that communications type for transmission through a port to a neighboring router on the NOC.

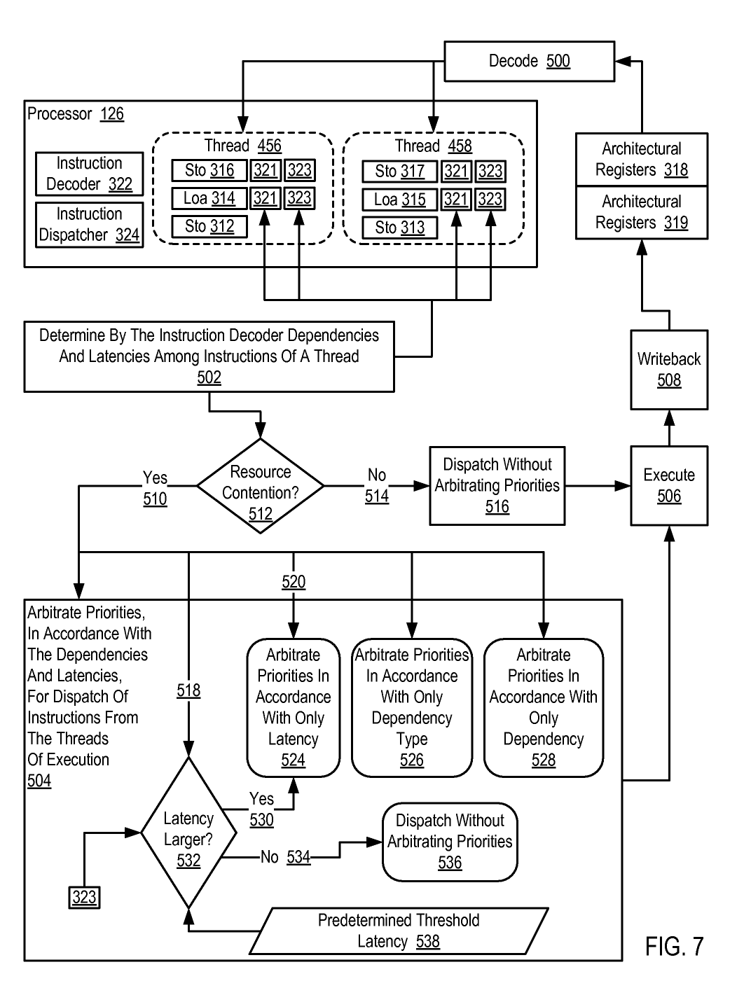

For further explanation, FIG. 7 sets forth a flow chart illustrating an exemplary method of operation of a computer processor (126) according to embodiments of the present invention. The method of FIG. 7 may be implemented on a computer processor having any form factor, a generally programmable computer, a microcontroller in an embedded system, a general-purpose microprocessor, a microprocessor in an IP block on a NOC, and in forms as may occur to those of skill in the art. In the example of FIG. 7, the computer processor (126) implements two or more pipelined hardware threads of execution (456, 458). Each thread includes a plurality of computer program instructions (300, 330, 332, 334, 336, 338). The computer processor also includes an instruction decoder (322) and an instruction dispatcher (324).

The method of FIG. 7 includes the instruction decoder's decoding (500) by computer program instructions from architectural registers into the processor's hardware threads of execution (456, 458) as microinstructions for dispatch, execution (506), and writeback (508). In the method of FIG. 7, the instruction decoder (322) also determines (502) dependencies (321) and latencies (323) among at least some of the instructions of the threads (456, 458). Some of the instructions (314, 316, 315, 317) in the threads have dependencies and latencies and some do not (312, 313). A dependency (321) is a requirement by one instruction for the execution results of another, earlier instruction in the same hardware thread of execution. Latency (323) is the amount of time or number of processor clock cycles a dependent instruction would be required to wait for the execution results of another instruction if the two were dispatched at the same time, without arbitrating priorities. Latency is function of dependency type, the kind of result or type of register value the dependent instruction requires. A logic operation or integer arithmetic in an ALU may have only a single clock cycle of latency. Memory operations and floating point math operations may have much larger latencies.

The method of FIG. 7 also includes a determination (512) by the instruction dispatcher whether resource contention is present among the instructions (300, 330, 332, 334, 336, 338) that are ready for dispatch in the hardware threads (456, 458). The instruction dispatcher decides that resource contention is present if there are more instructions of a same kind ready for dispatch than there are execution engines of the that kind. If the method of FIG. 7 is implemented, for example, with a set of execution units similar to that illustrated and described above with reference to FIG. 5, then only one STORE execution unit (332 on FIG. 5) would be available, and, if there were more than one STORE instruction (312, 316, 313, 317) ready for dispatch in the threads of execution (456, 458), then the instruction dispatcher would determine that resource contention is present. If no resource contention is present (514), the instruction dispatcher dispatches the instructions that are ready for dispatch in the threads without (516) arbitrating priorities among the instructions.

When resource contention is present (510) in the method of FIG. 7, the instruction dispatcher arbitrates (504), in accordance with the dependencies and latencies, priorities for dispatch of instructions from the plurality of threads of execution. The instruction dispatcher (324) can arbitrate priorities (504) between an instruction that has at least one instruction dependent upon it and another instruction having no instructions dependent upon it by granting priority to the instruction with a dependent instruction. The instruction dispatcher (324) can arbitrate priorities (504) between instructions each of which has one or more instructions dependent upon it by granting priority to the instruction with the highest latency.

Dependencies and latencies are relations among instructions in the same thread, but the instruction dispatcher arbitrates priorities among instructions across threads as well as instructions within the same thread. In the example of FIG. 7, there are four STORE instructions (312, 316, 313, 317) ready for dispatch in the threads, any one of which can next be dispatched to a STORE execution unit. With four STORE instructions ready for dispatch, there is resource contention even in a processor having as many as three STORE execution units. The resource contention therefore is among all four STORE instructions, two of which (312, 316) are in thread (456) and two of which (313, 317) are in thread (458). Readers will recognize that execution may proceed in any order with regard to individual instructions or microinstructions, with speculative results resolved, for example, according to which instructions are selected after a BRANCH or JUMP operation.

The example of FIG. 7 also illustrates four additional alternative ways of arbitrating priorities (504) according to embodiments of the present invention. One additional alternative way of arbitrating priorities in the presence of resource contention according to embodiments of the present invention is to arbitrate priorities for dispatch of instructions from the threads of execution in accordance with only dependency (528). This methodology simplifies arbitrating priorities by assigning priority only to instructions having one or more dependent instructions, regardless of latency. If two instructions contend for an execution resource and both have dependent instructions, then those two instructions are executed according to their sequence in the threads without arbitrating priorities between them. If the two instructions are at the same relative sequential locations in two separate threads, then the instructions are selected for dispatch by a round robin selection across the threads, for example.

A second additional alternative way of arbitrating priorities in the presence of resource contention according to embodiments of the present invention is to arbitrate priorities for dispatch of instructions from the threads of execution in accordance with only dependency type (526). This methodology assumes that each type of dependency, Boolean flag, integer arithmetic result, memory STORE operation, memory LOAD operation, floating point mathematic operation, and so on, are ordered according to latency and therefore arbitrates priorities among instructions in all the threads of execution purely according to the type of dependency that exists between two instructions in the same thread.

A third additional alternative way of arbitrating priorities in the presence of resource contention according to embodiments of the present invention is to arbitrate priorities for dispatch of instructions from the threads of execution in accordance with only latency (520, 524). Dependency and dependency type are ignored, and a dependency is observed in detail for each instruction dependent upon another instruction in the same thread. The instruction dispatcher give priority to instructions having dependents with higher latencies regardless of the size of the latency. That is, even instructions whose dependents have latencies of only a single clock cycle are dispatched with low priority.

Readers will recognize, however, that a single clock cycle may in some embodiments be considered too small a savings to justify a lower priority of dispatch for an instruction. A fourth additional alternative way of arbitrating priorities in the presence of resource contention according to embodiments of the present invention, therefore, is to arbitrate priorities for dispatch of instructions from the threads of execution in accordance with only latency (518, 524)—only if the latency (323) is larger than (530) a predetermined threshold latency (538). The predetermined threshold latency (538) is set to a value, a number of clock cycles or a time period, that represents a minimal justification for holding an instruction in dispatch and allowing a higher priority instruction to proceed to execution. This method is useful in embodiments in which some small number of processor clock cycles of stall in an execution unit does not represent sufficient inefficiency to justify holding a low priority instruction in a thread to wait for dispatch while a higher priority instruction is dispatched out of turn. This alternative method includes a determination (518, 532) whether latency (323) for an instruction is larger than a predetermined threshold latency (538). If the instruction latency is larger than (530) the predetermined threshold latency (538), then the instruction execution priority is arbitrated in accordance with only latency (524).

If the instruction latency is not larger than (534) the predetermined threshold latency (538), then the instruction is dispatched without arbitrating priority (536). There is still resource contention between this low priority instruction and another instruction, but the selection of which instruction to dispatch is done by round robin selection among the threads, according to the ordering or sequence of the instructions within the threads, or by some other method as will occur to those of skill in the art - but not by arbitrating priorities.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer processor comprising:
a plurality of pipelined hardware threads of execution, each thread comprising a plurality of computer program instructions;
an instruction decoder that determines dependencies and latencies among instructions of a thread; and
an instruction dispatcher that arbitrates, in the presence of resource contention and in accordance with the dependencies and latencies, priorities for dispatch of instructions from the plurality of threads of execution.

2. The processor of claim 1 wherein the instruction dispatcher further comprises an instruction dispatcher that arbitrates, in the presence of resource contention and in accordance with only dependency type, priorities for dispatch of instructions from the plurality of threads of execution.

3. The processor of claim 1 wherein the instruction dispatcher further comprises an instruction dispatcher that arbitrates, in the presence of resource contention and in accordance with only latency, priorities for dispatch of instructions from the plurality of threads of execution.

4. The processor of claim 1 wherein the instruction dispatcher further comprises an instruction dispatcher that arbitrates, in the presence of resource contention and in accordance with only latency and only if the latency is larger than a predetermined threshold latency, priorities for dispatch of instructions from the plurality of threads of execution.

5. The processor of claim 1 wherein the instruction dispatcher further comprises an instruction dispatcher that arbitrates, in the presence of resource contention and in accordance with only dependency, priorities for dispatch of instructions from the plurality of threads of execution.

6. The processor of claim 1 wherein the processor is implemented as a component of an integrated processor (‘IP’) block in a network on chip (‘NOC’), the NOC comprising IP blocks, routers, memory communications controllers, and network interface controller, each IP block adapted to a router through a memory communications controller and a network interface controller, each memory communications controller controlling communication between an IP block and memory, each network interface controller controlling inter-IP block communications through routers.

7. The processor of claim 6 wherein the memory communications controller comprises:
a plurality of memory communications execution engines, each memory communications execution engine enabled to execute a complete memory communications instruction separately and in parallel with other memory communications execution engines; and
bidirectional memory communications instruction flow between the network and the IP block.

8. The processor of claim 6 wherein each IP block comprises a reusable unit of synchronous or asynchronous logic design used as a building block for data processing within the NOC.

9. The processor of claim 6 wherein each router comprises two or more virtual communications channels, each virtual communications channel characterized by a communication type.

10. The processor of claim 6 wherein each network interface controller is enabled to convert communications instructions from command format to network packet format and implement virtual channels on the network, characterizing network packets by type.

11. A method of operation for a computer processor, the computer processor implementing a plurality of pipelined hardware threads of execution, each thread comprising a plurality of computer program instructions, the computer processor comprising an instruction decoder and an instruction dispatcher, the method comprising:
determining by the instruction decoder dependencies and latencies among instructions of a thread; and
arbitrating by the instruction dispatcher, in the presence of resource contention and in accordance with the dependencies and latencies, priorities for dispatch of instructions from the plurality of threads of execution.

12. The method of claim 11 wherein arbitrating priorities further comprises arbitrating by the instruction dispatcher, in the presence of resource contention and in accordance with only dependency type, priorities for dispatch of instructions from the plurality of threads of execution.

13. The method of claim 11 wherein arbitrating priorities further comprises arbitrating by the instruction dispatcher, in the presence of resource contention and in accordance with only latency, priorities for dispatch of instructions from the plurality of threads of execution.

14. The method of claim 11 wherein arbitrating priorities further comprises arbitrating by the instruction dispatcher, in the presence of resource contention and in accordance with only latency and only if the latency is larger than a predetermined threshold latency, priorities for dispatch of instructions from the plurality of threads of execution.

15. The method of claim 11 wherein arbitrating priorities further comprises arbitrating by the instruction dispatcher, in the presence of resource contention and in accordance with only dependency, priorities for dispatch of instructions from the plurality of threads of execution.

16. The method of claim 11 wherein the processor is implemented as a component of an integrated processor (‘IP’) block in a network on chip (‘NOC’), the NOC comprising IP blocks, routers, memory communications controllers, and network interface controller, each IP block adapted to a router through a memory communications controller and a network interface controller, each memory communications controller controlling communication between an IP block and memory, each network interface controller controlling inter-IP block communications through routers.

17. The method of claim 16 wherein the memory communications controller comprises:
a plurality of memory communications execution engines, each memory communications execution engine enabled to execute a complete memory communications instruction separately and in parallel with other memory communications execution engines; and
bidirectional memory communications instruction flow between the network and the IP block.

18. The method of claim 16 wherein each IP block comprises a reusable unit of synchronous or asynchronous logic design used as a building block for data processing within the NOC.

19. The method of claim 16 wherein each router comprises two or more virtual communications channels, each virtual communications channel characterized by a communication type.

20. The method of claim 16 wherein each network interface controller is enabled to convert communications instructions from command format to network packet format and implement virtual channels on the network, characterizing network packets by type.
